(19) United States
(12) Patent Application Publication
(10) Pub. No.: US 2015/0069125 A1
(43) Pub. Date: Mar. 12, 2015

(54) ACTIVE CONTACT AND NEAR-FIELD CARD READING DEVICE AND METHOD THEREOF

(71) Applicant: COATMEN TECHNOLOGY INTEGRATION LIMITED, New Taipei City (TW)

(72) Inventor: CHIN-TING HO, New Taipei City (TW)

(73) Assignee: COATMEN TECHNOLOGY INTEGRATION LIMITED, New Taipei City (TW)

(21) Appl. No.: 14/020,899

(22) Filed: Sep. 9, 2013

(51) Int. Cl. G06K 7/00; G06K 7/06; G06K 7/10

(52) U.S. Cl. CPC G06K 7/0004; G06K 7/10009; G06K 7/065
USPC 235/441; 235/439

(57) ABSTRACT

The present invention relates to an active contact and near-field card reading device and a method thereof, which are a device and a method for being attached to a mobile information device to carry out mobile payment and of which the structure includes a transmission cable. The transmission cable has two ends respectively provided with an audio connector and a reading head. The reading head includes an ISO 7816 reading module and an ISO 14443 reading module. With the above described structure and being operated with the following method: (a) inserting an audio connector into an audio jack of a mobile information device; (b) moving a reading head to approach a reading target; and (c) proceeding with a reading operation, by means of the structure and operation method according to the present invention, actively approaching and matching various specifications of electronic identification card can be made to proceed with a reading operation, so that practical advantages of actively approaching and being secure can be achieved.

### TECHNICAL FIELD OF THE INVENTION

The present invention generally relates to an active card reading device that is attachable to a mobile information device, and more particularly to an active contact and near-field card reading device and a method thereof, which feature active approaching and being of security

### DESCRIPTION OF THE PRIOR ART

Electronic identification cards, which are also referred to as plastic money, are of various specifications and definitions for use in combination with corresponding reading means to proceed with data reading and writing for the purposes of substituting the traditional ways of transactions made with currency so as to make living more convenient.

This mode of transaction based on electronic identification card faces many challenges and difficulties, such security issue and convenience issue. The conventional electronic identification cards are generally read with two reading modes, which are contact type and non-contact type. The most well-known contact type electronic identification cards are credit/bank card, wherein reading and writing of data are accomplished through contact made between a reading device and a card for completing a transaction. During such a process, the electronic identification card may be readily subjected to malicious activity of unauthorized persons, such as card misappropriation or card number duplication and skimming, and this causes major damages of the cardholder.

As to the other type, the non-contact type, electronic identification card, the most famous ones are the MRT travel card and paying cards of convenient stores, which proceed with reading and writing of data through induction. The sensor of such a reading mode is generally fixed at a specific site and thus, the card must be placed very close to the sensor in order to achieve induction. This may cause inconvenience of use for the disabled or in case of being affected by an external environment.

The proceed with reading and writing of data for the above described reading device and card, the commonly used mode of operation is to “bring the card to the device”, meaning the card must be inserted into the contact type card reading device (such as an automatic teller machine, money transfer or paying tax made through internet banking) or the card must be place very close to a non-contact type card reading device (such as MRT gate, bus, parking lot, or consumption made in a supermarket). Operating in this way may readily cause security concern for the card reading device may not be in sight. Particularly, mobile devices are prevailing nowadays, such an operation mode of “bringing the card to the device” is in hindrance for popularization, making it hard to get popularized and not meeting the diversified needs of the personal activities.

Further, the living standard of the modern society is getting increasingly high and there will be more applications that require separate use of such technology or even simultaneous use of such technology. If the sensor is incapable of responding to such applications, inconvenience of use may also result.

Thus, it is desired to dissolve the problems and shortcomings of the conventional ways of induction and reading of electronic identification cards and this is a challenge for the present inventor and the manufacturers of this industry

### SUMMARY OF THE INVENTION

In view of the above problems, the present invention aims to provide an active contact and near-field card reading device and a method thereof, which feature active approaching and being of security.

The primary object of the present invention is to carry out a card reading operation through connection with a mobile information device so that reading is performed by means of a reading head of active approaching fashion, which is operated in combination with dual reading mode of ISO 7816 reading module and ISO 14443 reading module respectively corresponding to contact type and non-contact type reading processes, whereby with the above technology, the problems concerning security and convenience of the conventional electronic identification card sensor can be overcome and a practical advantage of active approaching and being secure can be achieved.

To achieve the above object, the present invention provides an active contact and near-field card reading device, of which the structure comprises a transmission cable, and audio connector, a reading head, and ISO 7816 reading module, and an ISO 14443 reading module. The transmission cable has an end coupled to the audio connector and an end that is distant from the audio connector and is coupled to the reading head. The reading head receives both the ISO 7816 reading module and the ISO 14443 reading module mounted thereto.

With the above structure, the following method may be carried out:
(a) inserting an audio connector into an audio jack of a mobile information device;
(b) moving a reading head to approach a reading target; and
(c) proceeding with a reading operation.

As such, with the above structure and operation method, in sensing and reading of an electronic identification card, the reading head is manipulated to actively approach the card in order to proceed with sensing and reading to complete a transaction. Thus, the reading operation can be completed with the electronic identification card maintained in sight of the card holder and within a secured range thereby significantly reduce the inconvenience of use and achieving practical advantages of active approaching and being secure.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is a block diagram of the preferred embodiment of the present invention.

FIG. 3 is a flow chart of the preferred embodiment of the present invention.

FIG. 4 is a schematic view illustrating the use of the preferred embodiment of the present invention.

FIG. 5 is another schematic view illustrating the use of the preferred embodiment of the present invention.

FIG. 6 is a further schematic view illustrating the use of the preferred embodiment of the present invention.

FIG. 7 is a perspective view of another preferred embodiment of the present invention.

FIG. 8 is a perspective view of a further preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

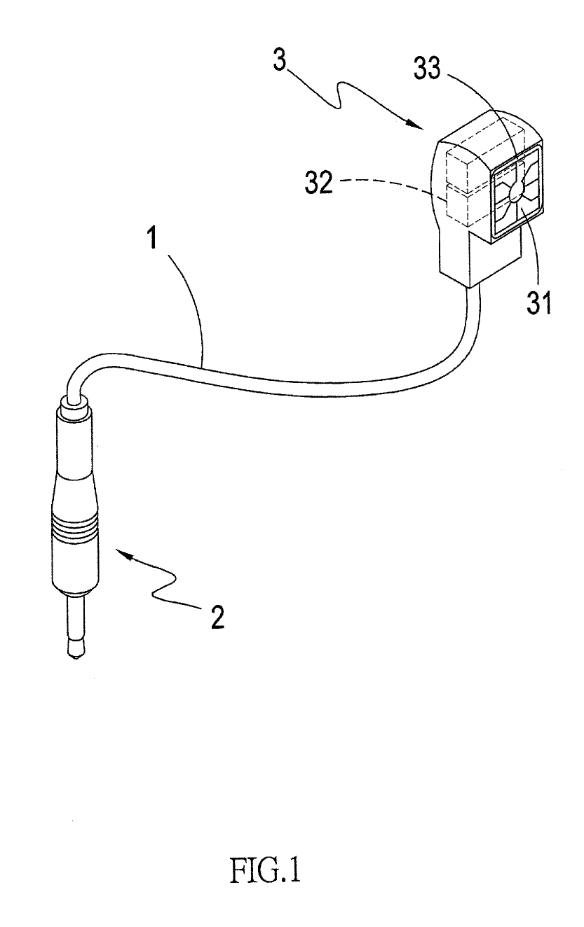

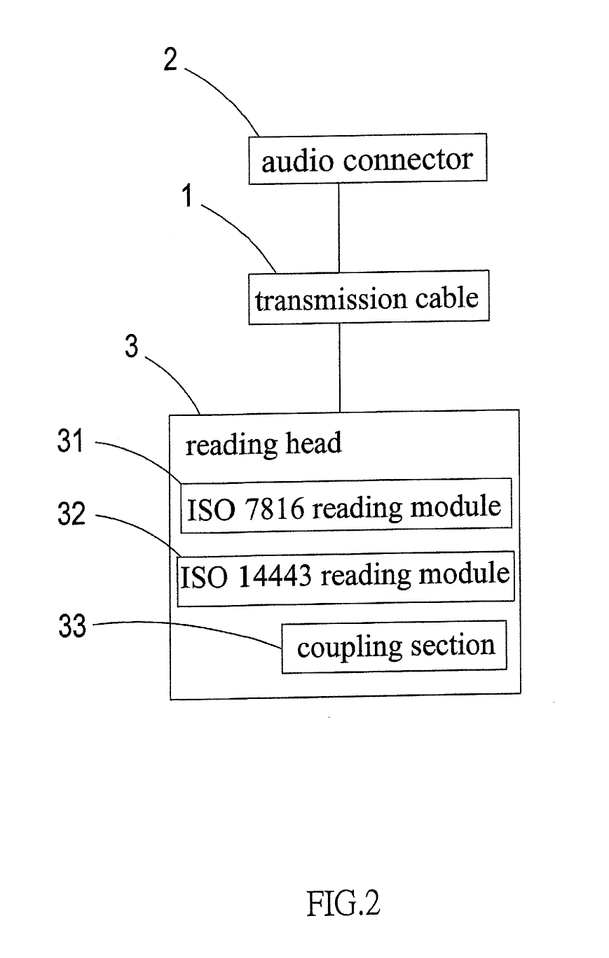

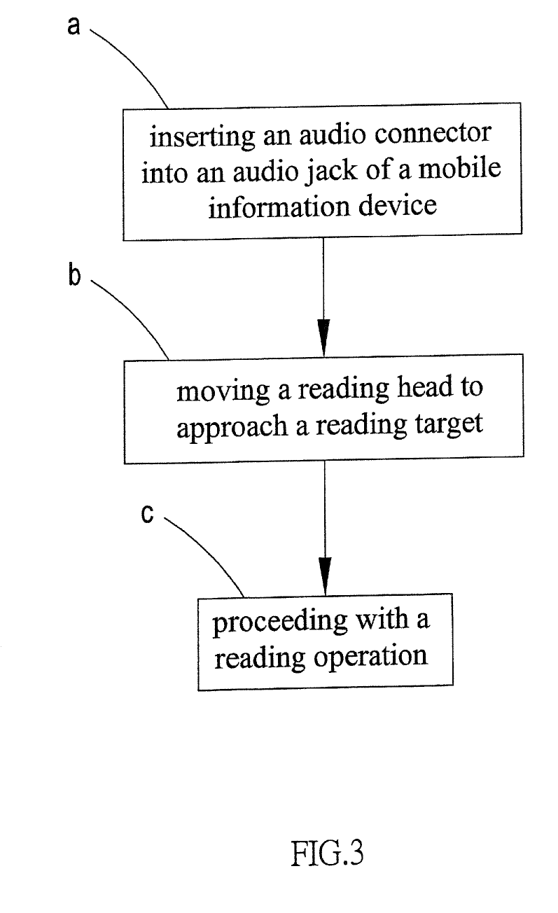

Referring to FIGS. 1, 2, and 3, which are respectively a perspective view, a block diagram, and a flow chart of a preferred embodiment of the present invention, these drawings clearly show that the present invention comprises:
a transmission cable 1;
an audio connector 2 coupled to an end of the transmission cable 1;
a reading head 3 coupled to an end of the transmission cable 1 that is distant from the audio connector 2;
an ISO 7816 reading module 31 mounted to the reading head 3; and
an ISO 14443 reading module 32 mounted in the reading head 3.

The reading head 3 comprises a coupling section 33 formed thereon.

The flow of the steps of the method is as follows:
(a) inserting an audio connector into an audio jack of a mobile information device;
(b) moving a reading head to approach a reading target; and
(c) proceeding with a reading operation.

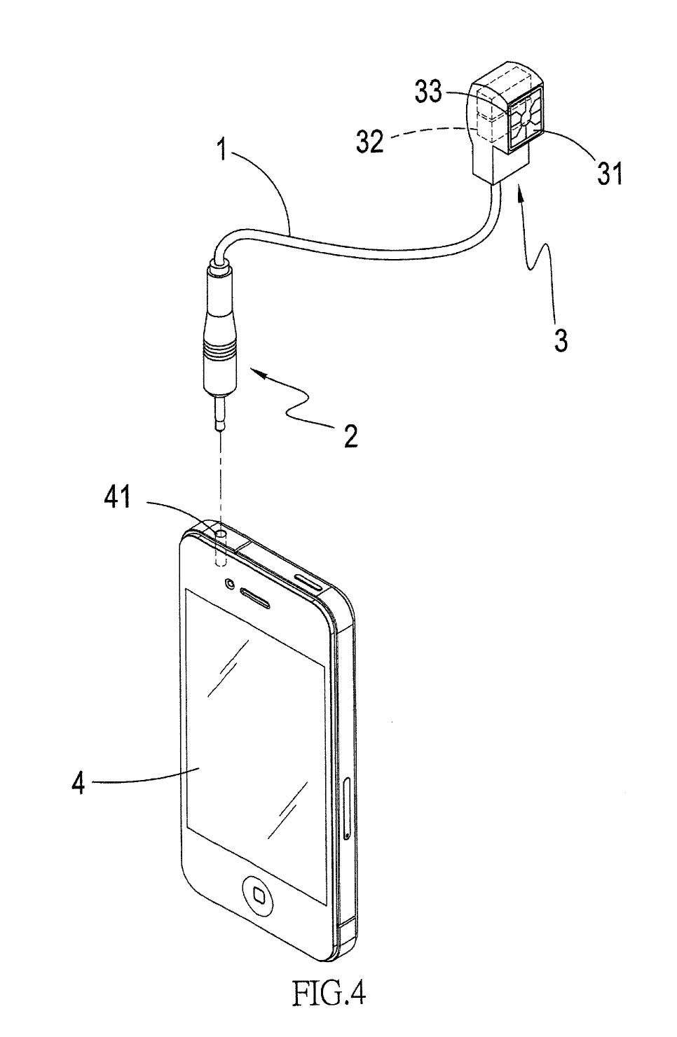

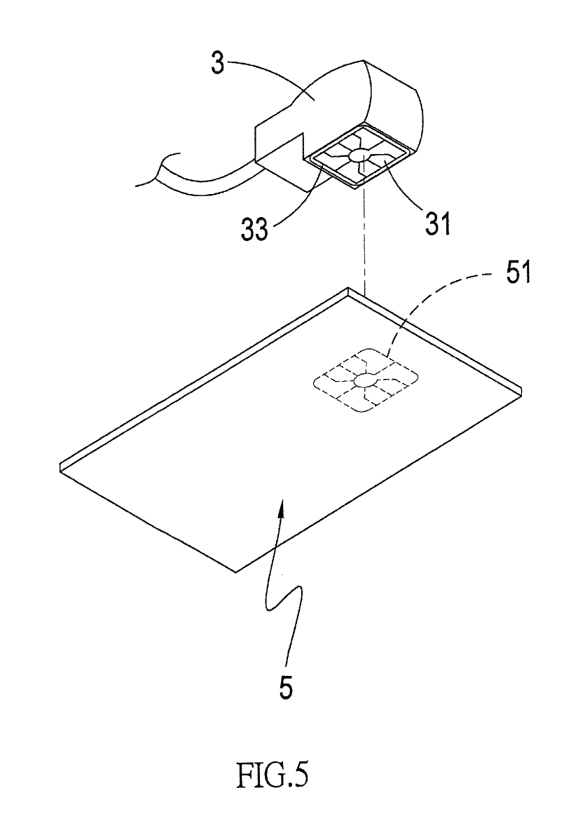

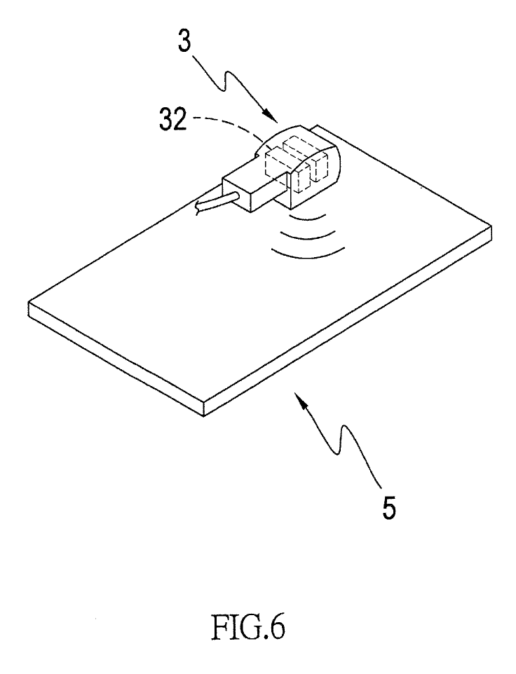

Also referring to FIGS. 4, 5, and 6, which are respectively a schematic view, another schematic view, and a further schematic view illustrating the use of the preferred embodiment, these drawings clearly show that when the device according to the present invention is used to read an electronic identification card 5, an audio connector 2 is inserted into an audio jack 41 formed on a mobile information device 4 to establish information communication and afterwards, an active card reading operation can proceed. In the instant embodiment, the coupling section 33 comprises a repeatedly attachable adhesive. The coupling section 33 can certainly be of other types of fastening structure. When the electronic identification card 5 is of a specification (ISO 7816) of the standard of a contact type electronic identification card 5, the reading head 3 can be held by a hand in such a way that the ISO 7816 reading module 31 is set in alignment with a metal induction zone 51 of the electronic identification card 5 for contacting therewith to proceed with transmission of information. Due to fastening effect provided by the coupling section 33, a stable contact can be achieved between the ISO 7816 reading module 31 and the metal induction zone 51 so that no error will occur until the reading operation is completed. After the completion of the operation, the ISO 7816 reading module 31 is separated from the electronic identification card 5. When the electronic identification card 5 is of a specification (ISO 14443) of non-contact type integrated electronic identification card 5, similarly, the reading head 3 is held by a hand and is actively moved to approach the electronic identification card 5, whereby when the reading head 3 and the electronic identification card 5 are close enough to be located within a transmission range, the reading operation is started in such a way that induction is achieved through antennas contained in the ISO 14443 reading module 32 and the electronic identification card 5 to realize the operation of reading. For either the contact type sensing or non-contact type sensing, the reading head 3 is held by a hand to be actively moved to approach the electronic identification card 5 and operated in combination with the transmission cable 1 to transmit information so that during the entire card reading operation, the electronic identification card 5 is kept in the sight of the card holder (or a secure range) to prevent card misappropriation or card number duplication or skimming of the electronic identification card 5. Also due to the mode of actively approaching (a concept of actively moving the reading head 3 to approach the electronic identification card 5), the advantage of convenience of use can be similarly accompanied. As such, with the above described structure and method, a practical advantage of actively approaching and being secure can be achieved.

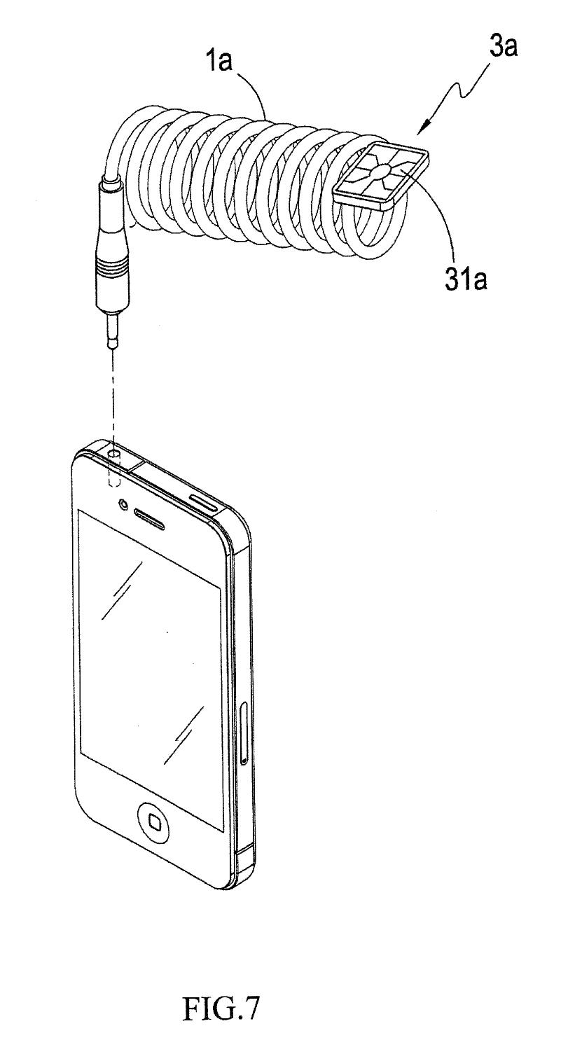

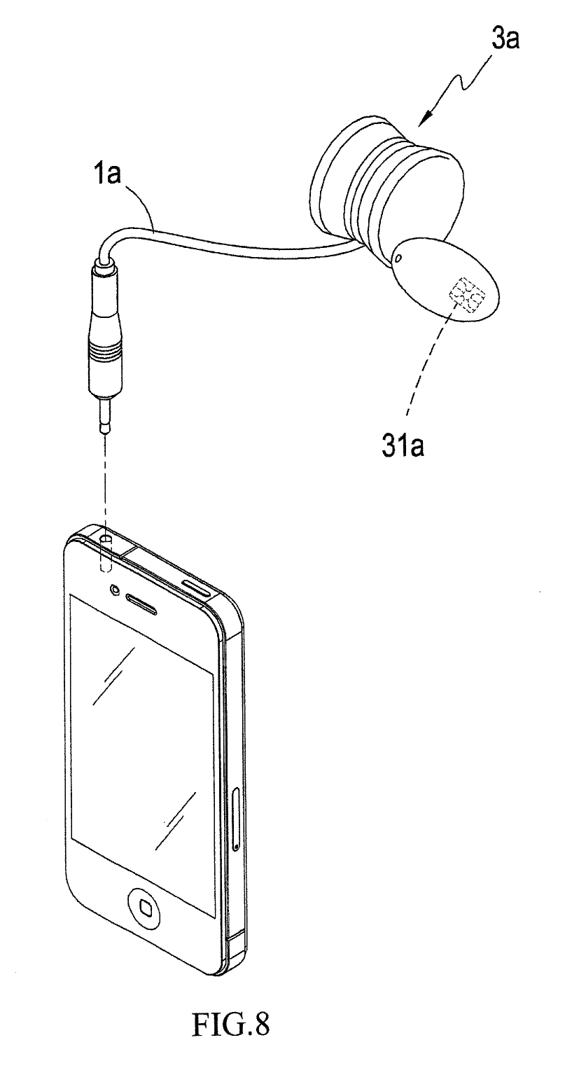

Referring to FIGS. 7 and 8, which are respectively a perspective view showing another preferred embodiment of the present invention and a perspective view showing a further preferred embodiment of the present invention, it can be seen from FIG. 7 that in this embodiment, the transmission cable 1a is made in the form of an elastic coil, which may make the use thereof more interesting. It can be seen from FIG. 8 that in this embodiment, the reading head 3a is made in the form of a slide cover, whereby normally, the ISO 7816 reading module 31a is stored in the cover. To use, the cover is rotated open to expose the ISO 7816 reading module 31a for contact and transmission. Further, the reading head 31a is provided with a reeling mechanism so that the transmission cable la can be normally stored in the reading head 3a and in use, the transmission cable 1a is pulled out of the reading head 3a. The operations of the device for these two embodiments are similar to what described for the previous embodiments so that repeated description will be omitted here.

Thus, the technical features of the active contact and near-field card reading device of the present invention and the method thereof that improve the prior art are as follows:

(1) With the arrangement of the reading head 3 and the transmission cable 1 and the feature of actively approaching a sensing target, the conventional way of bringing the electronic identification card 5 to the sensor is improved so as to achieve the advantages and improvements of actively approaching and being secure.

(2) The reading head 3 is provided with both a contact type reading module (ISO 7816 reading module 31) and a non-contact reading module (ISO 14443 reading module 32), which enables operability with respect to various electronic identification cards 5, thereby achieving the advantage and improvement of being convenient to use.

(3) The reading head 3 comprises a coupling section 33 to match various types of electronic identification card 5 or other variations of fastening structure so that stable contact can be ensured between the reading head 3 and the electronic identification card 5 to realize correctness of sensing and reading.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An active contact and near-field card reading device, comprising:
a transmission cable;
a connector coupled to an end of the transmission cable;
a reading head coupled to an end of the transmission cable that is distant from the connector;
a contact type reading module mounted to the reading head; and
a non-contact type reading module mounted in the reading head.

2. An active contact and near-field card reading device, comprising:
a transmission cable;
an audio connector coupled to an end of the transmission cable;
a reading head coupled to an end of the transmission cable that is distant from the audio connector,
an ISO 7816 reading module mounted to the reading head; and
an ISO 14443 reading module mounted in the reading head.

3. The active contact and near-field card reading device according to one of claims 1, wherein the reading head comprises a coupling section formed thereon.

4. The active contact and near-field card reading device according to one of claims 2, wherein the reading head comprises a coupling section formed thereon.

5. A method for active and near-field reading card, comprising the following steps:
(a) inserting an audio connector into an audio jack of a mobile information device;
(b) moving a reading head to approach a reading target; and
(c) proceeding with a reading operation.

6. The method for active and near-field reading card according to claim 5, wherein the reading target is of the specification (ISO 7816) of a contact type electronic identification card standard and the reading head needs to contact the reading target to proceed with a reading operation.

7. The method for active and near-field reading card according to claim 5, wherein the reading target is of the specification (ISO 14443) of a non-contact type integrated electronic identification card standard and the reading head needs to get close to the reading target to proceed with a reading operation.
